(19) United States
(12) Patent Application Publication
(10) Pub. No.: US 2008/0040252 A1
(43) Pub. Date: Feb. 14, 2008

(54) System And Method For Tracking Future Endowment Gifts

(76) Inventor: Richard J. Enna JR., Overland Park, KS (US)

Correspondence Address: LATHROP & GAGE LC, 2345 GRAND AVENUE, SUITE 2800, KANSAS CITY, MO, 64108, US

(21) Appl. No.: 11/836,005

(22) Filed: Aug. 8, 2007

Related U.S. Application Data
(60) Provisional application No. 60/836,216, filed on Aug. 8, 2006.

(51) Int. Cl. G06Q 40/00; G06Q 10/00

(52) U.S. Cl. 705/36 R

(57) ABSTRACT

A method for an organization to monitor the projected amount and date of receipt of an endowment bequest comprising a benefactor, through an associated agent, entering into a financial instrument bequeathing a set percentage of the instrument's proceeds, a third party entering into a database the value of the financial instrument, the percentage of the bequest assigned to the not-for-profit and the age of the benefactor; the third party calculating the value of the endowment gift based upon the current value of the financial instrument and the percentage bequeathed to the not-for-profit organization at the actuarially computed date of death of the benefactor; the third party advising the not-for-profit organization on a regularly scheduled basis of the current value of the pooled endowment gift and the projected date of receipt of the gift; the third party alerting the not-for-profit organization of a change in the status of the benefactor's financial instrument.

### RELATED APPLICATIONS

This application claims benefit to U.S. Provisional Application No. 60/836,216 filed on Aug. 8, 2006, the disclosure of which is incorporated by reference herein.

### TECHNICAL FIELD

There is disclosed a method for using financial instruments, typically in the form of a modified endowment contract (MEC), life insurance policy, annuity, individual retirement account, transfer on death account or any type of account with an intended beneficiary program to provide future funds to non-profit organizations (NPOs), and in particular, endowment funds associated therewith and the ability to monitor the status of those financial instruments.

### BACKGROUND

Funding is a crucial component for non-profit organizations, such as universities, colleges, research institutes, think tanks, and other beneficial organizations. Funding is such a great need, that these organizations employ full time fundraisers, and directors of giving, in order to work with key donors, for example, high income and high net worth individuals, families, family foundations and the like, to provide donations in large amounts, so as to have an endowment fund, or endowment for the organization.

Traditionally, endowments have been created from trusts, lump sum gifts, and other large donations of property such as real estate, businesses, and the like. These trusts and lump sum gifts and donations, are typically derived from complicated estate plans, in wills and other documents, that are expensive to create. These plans may be so complicated, that potential donors simply do not want to go through the time, trouble or expense to set up such plans. Moreover, even if an organization is mentioned in a will, estate plan or the like, there is not any way to reliably track that the gift will still be part of the estate plan during the donor's life, other than continuously asking and reminding the donor to remember the institution in their will or estate plan. This is simply not done, as it is impolite, and liable to create tension between the donor and the organization. Moreover, according to many sources, including survey research as many as 55 to 70% of Americans do not have wills, which suggests most Americans have not done proper estate planning.

Additionally, when giving a gift, if living, the donor loses all control of the money or property given as a gift. If for some reason, the donor needs cash at a future date, it would not be available from these finds or property, as all rights and title passed to the organization with the gift.

Moreover, many key donors, donate regularly to these organizations, to fund them on a regular basis, for their normal everyday operations. Accordingly, it is difficult to approach these same people to establish an endowment, essentially asking for yet another large amount, above an already committed large amount, due to their already being key donors. Although many key donors leave these organizations in their estate plans, many never complete their intended estate plans, and assets intended for the organization are never received.

### SUMMARY

To give some sense of the magnitude of the dollar amounts that are being donated to NPOs, the American Association of Fundraising Counsel estimates that in the year 2002, over $240.92 billion went into the coffers of NPOs. Charitable giving continues to grow at roughly one percent per year and presently has been averaging about 2.3 percent of gross domestic product.

Disclosed is a system and method for funding an entity, for example, a NPO, to a predetermined amount at a predetermined time, typically to create or add to an endowment or other funds pool for the organization. The disclosed system and method does not replace an NPO's responsibility of trying to raise endowment. Its focus is to help ensure that in spite of the NPO's best efforts to raise endowment, their objectives are met at a future date. The system and method focuses on those who intend to leave a gift at a future date, but are not ready to give at this time. This system and method works with accounts, specifically MECs, life insurance policies, annuities, IRAs, transfer on death accounts, or any type of account that has a beneficiary provision, that would allow the ownership of part or all of any account to go to an intended beneficiary directly, without going through a probate process. It is public knowledge that many people don't have a will, or do proper estate planning, so their intended wishes are never carried out. In fact, it has been estimated that between 55% and 70% of Americans do not have wills. It is argued that every NPO, regardless of success in creating endowment, has not figured out a way to significantly increase their ability to capture funds intended for the NPO, but not yet gifted, because the donor is not ready to give at this time. Much like the will that goes unexecuted, and wishes not carried out, significant dollars never reach the NPO, and they never knew these funds were intended for them in the first place.

If the NPOs had an efficient, barrier—free method for capturing these beneficiary gifts; had an ability to track not only the amount, but an approximate time in which they may become available; had knowledge of changes made to these accounts, so they could go back to donor base and raise more beneficiary gifts, the endowment objectives the NPO desires has a significantly higher chance of being met.

All NPOs can participate in the disclosed system and method by simply paying a fee to a third party in order to belong. Once a fee is paid, an NPO becomes part of the database maintained by the third party. The database reports the name of the NPO, NPO monetary endowment objective, approximate time period in which endowment funds may become available and the actual dollar value of accounts that have been earmarked for the NPO. The system and method operates by having all donors who have made the NPO a beneficiary on all or part of their account, and the percentage intended for the NPO and the average life expectancy included in the combined pool. This information, when properly manipulated in a fashion that is well known by those skilled in the financial profession, provides a good approximation of when funds earmarked for endowment may become available based upon life expectancy tables published by the Internal Revenue Service or tables accepted by the Life Insurance and Securities Industries.

Additionally, the pool total could also be segmented into different pools: Pool life expectancy greater than 20 years; 15 to 20 years; 10 to 15 years; 5 to 10 years; 0 to 5 years. Although individual dollar amounts, by default are not reported, to ensure confidentiality, beneficiary gift donors would have the option of having their name listed on this report, or be anonymous. The database would be updated for new accounts created, as well as any changes to the accounts. The NPO would have access to their database online by username and password on a daily basis (or paper reports could be provided). Information could be used by the NPO for reporting purposes, when fund raising, reporting to donor base, although not assets of the NPO.

Accounts, pursuant to the disclosed system and method are set up with tracking ability as follows: Life Insurance Companies, Mutual Fund Companies, Banks, Investment Brokerage Companies, and any other entity who creates accounts or products with beneficiary provisions may either purchase the ability to link their accounts to the third party database, which includes linking these companies' clients up with all NPOs in database; or if they outsource record keeping, choose to outsource with a reporting organization that offers the third party database.

The barriers to successful endowment fund raising for the NPO and donor are listed above. When a NPO participates in the disclosed system and method, they have the opportunity to further leverage fund raising ability by tapping all of the financial advisors in their NPO community. The financial advisers are best suited to help a current NPO development specialist in this area. They certainly don't take the place of the NPO raising endowment dollars, but they tap the above mentioned ‘intended but not ready’ market, which is considerable. The additional potential barrier that comes up is “playing favorites,” that is, allowing a certain financial advisor(s) access to donors, conducting business that benefits both donor and NPO objectives, but at the expense of alienating other financial advisers who are donors, or have donors as clients, or who could negatively publicize to donor community the favoritism).

Although it may make sense to some NPOs to work with one financial advisor, and others it doesn't, the disclosed system and method provides an NPO the ability to open the system and method up to all advisors, because the tracking process is not limited to one company, or one product. Until the database is built up to include relationships with the above financial organizations, as well as participating NPOs, the tracking process will rely upon tracking beneficiary information from accounts where beneficiary gift donor has authorized the financial company to report above information to the third party, who will make reports available, either online or provide a paper report, to the NPO.

### BRIEF DESCRIPTION OF THE DRAWINGS

Attention is now directed to the attached drawings. In the drawings:

FIG. 1 is a flow diagram of the disclosed method.

### DETAILED DESCRIPTION

The method disclosed herein eliminates the aforementioned problems, as it provides a comfortable way to approach a key donor, instrumental in funding the present needs of an organization, without contributing more to the organization at this time for future needs. The disclosed method allows for a creation of an endowment by traditional means, and works alongside these traditional means, providing funding to the endowment in the future. The disclosed method also allows organizations to continue to work towards obtaining endowments traditionally, while the funds designated for endowment remain under the individual donor's control, until a future, event, for example, death, and the organization has the ability to track the status of these future funds, earmarked for the endowment.

According to the national center for charitable statistics, there are almost 1.5 million NPOs in the United States, the majority of whom could benefit from this disclosed method. Virtually no NPOs have an efficient mechanism to track dollars intended for them, in the distant future, but not yet gifted. The vast majority of NPO's spend most of their resources raising money to keep the lights on and doors open, and/or for a building campaign. Although building an endowment fund for the NPO is a high priority (because the existence of this fund may result in perpetual funding to keep the entity in operation, provide scholarships, building maintenance and the like), in practice it is usually the last account created, because most energy and commitment is directed toward present needs such as operational and building maintenance costs, or building campaigns.

The disclosed method takes advantage of U.S. Tax laws, in that it involves using instruments, such as a MECs, defined and governed by Internal Revenue Code Section 7702, annuities, non MEC life insurance contracts, and individual retirement accounts, among others, to provide the requisite funds to the designated endowment at a future time. It is important to recognize that the current value of a financial instrument from a life insurance company may consist of a death benefit which may have different value than the cash value of the instrument.

By using MECs, the donor receives a guaranteed rate of return on cash value accumulation, in additional to a current rate. The donor has immediate access to cash values by loan or withdrawal. The donor's principal does not fluctuate, with part of the principal paying for the cost of the insurance, while the remaining funds are in a professionally managed pool of funds, as managed by the insurance company. An agent of record is present on the MEC, or other financial instrument, and through the agent of record and/or the company associated with the financial instrument provide the information to the third party so the organization who is the beneficiary knows the status of the MEC and the amount of the benefit designated for it.

By using the disclosed system and method, the donor owns the financial instrument, whether it be a life insurance policy, a MEC, an annuity, an individual retirement account or a transfer on death account, and accordingly controls the funds up until the requisite event, that is the death of the donor. The donor can access cash during the life of the financial instrument, as well as change the beneficiary during this instrument's life.

The disclosed method provides for a not-for-profit organization to monitor the projected amount and estimated date of receipt of an endowment bequest wherein a benefactor, with the assistance of an associated agent, enters into a financial instrument bequeathing a set percentage of the instrument's proceeds to the not-for-profit organization. The associated agent may be affiliated with a life insurance company, a mutual fund company, an investment brokerage company or any other type of entity that creates accounts or products with beneficiary provisions.

A third party, for example but not limited to, a limited liability company, organized to implement the system and method, enters into a database, the pertinent data including the value of the financial instrument, the percentage of the bequest assigned to the not-for-profit and the age of the benefactor. The third party then calculates the value of the endowment gift based upon the current value of the financial instrument and the percentage bequeathed to the not-for-profit organization at the actuarially computed date of death of the benefactor. The third party then advises the not-for-profit organization, on a regularly scheduled basis, of the approximate current value of the endowment gift and the projected date of receipt of the gift. The third party is also responsible for alerting the not-for-profit organization of a change in the status of the benefactor's financial instrument such as when the benefactor revises the financial instrument to change the percentage to be bequeathed, or possibly completely revokes the instrument potentially leaving a significant shortfall for that not-for-profit organization during a particular future time period.

Also by using the disclosed method, the organization, who is the beneficiary of the MEC, and other financial instruments, can regularly see the total death benefit of all pooled financial instruments in place for which it is the beneficiary. This is typically in a report accessed by the NPO on line or a periodic letter sent by the third party to the NPO. The report compares the death benefit in force with the projected future needs of the NPO, and within this death benefit amount could also compare the death benefit in place on certain key donors with the potential loss of cash flow to the organization, should a key donor die unexpectedly. The key donor, as owner of the MEC, or other financial instruments, gives the third party or agent of record on the MEC, or other financial instrument, the authority to share beneficiary information with the organization, while maintaining the owner's right to privacy. For example, the key donor, as owner of the MEC, or other financial instrument, may authorize the agent of record, or third party to disclose the amount of death benefit earmarked for the organization, however, if a change in beneficiary occurs, they only want the organization to be notified that the total death benefit of all financial instruments in force has been reduced, without the organization knowing which donor made the change.

### The Future Needs Funding Program™

The Future Needs Funding Program™ (FNFP) is a system and method created to assist not-for-profit organizations (NPO) with successfully completing an endowment program, designed to perpetuate the organization, or provide for it in some fashion, for future generations. This method helps complete these endowment objectives, without replacing or compromising the NPO's current best efforts in this area.

The system and method involves two main components:
1) Without giving the funds away, a benefactor usually transfers funds from a conservative account, like a CD, to an alternative account, usually an instrument known as a modified endowment contract (MEC), which is a type of life insurance policy, alternatively, an annuity, an individual retirement account or any transfer on death account may also be used. The goal of the NPO is to put whatever number of MECs, or other types of financial instruments, if applicable, in place, that are necessary for the combined death benefit to equal or exceed the NPO's endowment goal. An associated agent, such as an agent from a life insurance company or a mutual fund company assists the benefactor in selecting and completing the requisite documentation to place the instrument in service. A critical aspect of the role of the associated agent, and his affiliated company, is the role that this individual and the insurance company or other company responsible for the making the payout has in monitoring and reporting any changes in the status of the financial instrument to the third party that has been established to provide updates to the NPO.
2) The NPO receives the ability to access the periodic report on line or pay for a report from the third party. The report provides important information pertaining to the potential endowment funds created through The Future Needs Funding Program™. Specifically, that information is the date the program was implemented; the year the NPO anticipates beginning to receive endowment funds; actuarially determined earliest and average life expectancies based upon all of the policies in force, so the NPO can determine approximately how soon the funds may be available, as compared with the anticipated date in which the funds will be needed; the number of policies in force in which donors are insured and for which the NPO is the beneficiary; the actual monetary endowment goal determined by the NPO; the total amount of death benefit on the policies in force, in which the NPO is beneficiary, so the NPO can compare this amount with the actual monetary endowment goal.

For those NPO's who have key donors, whose death could impact the viability of the NPO, the report could also contain the following: 1) the projected dollar amount, derived by the NPO, needed to replace income lost by the death of the key donor(s); the death benefit included in the policies in force, based upon the lives of the key donors, so the NPO can compare their goal for funds needed to replace income lost due to death of a key donor, with the total death benefit in force on the key donors' lives.

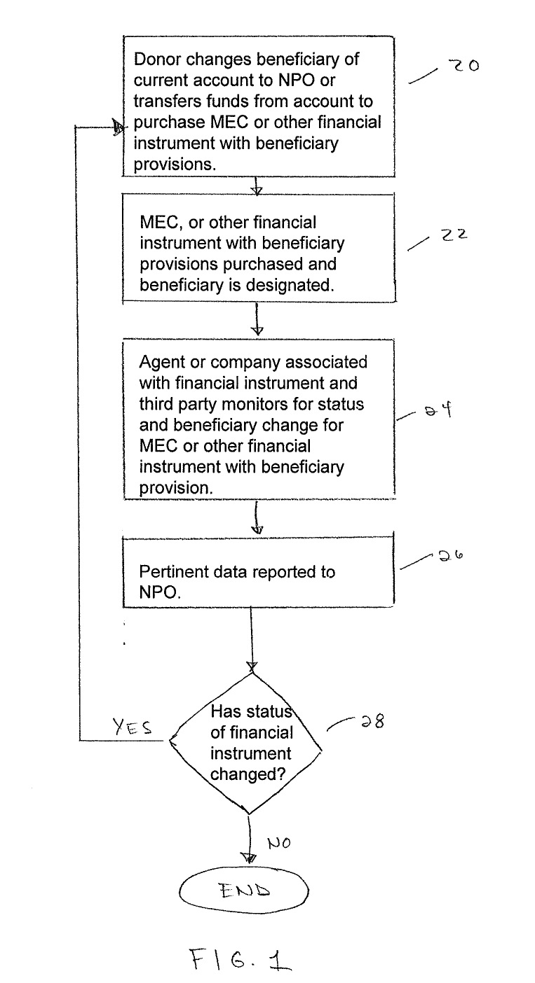

Exemplary steps for implementation of the disclosed system and method are as follows, and are shown in the flow diagram of FIG. 1, to which attention is directed.
1. Approach the director in charge of development for the NPO.
2. After reviewing the FNFP presentation by the FNFP representative, if NPO director believes that the FNFP is a fit for the NPO, the NPO's endowment goals are reviewed and identified, as well as those key donors who may be able to fund the FNFP. This is a method and system designed to be used with, but not limited to, key donors to the NPO (those who could afford to move money from a current account to the alternative account, without affecting their lifestyle). Donors and prospective donors may be able to change the beneficiary on the designated financial instrument as opposed to purchasing new financial instruments.
3. The director sets up appointments for the key donors.
4. A FNFP representative makes the FNFP presentation to the donor.
5. If the donor is interested, the NPO director hands the donor off to the FNFP representative to further discuss to what extent the donor will participate; and they work together to put policies in force or change beneficiaries on existing financial instruments. For example, turning to the flow diagram of FIG. 1, at block 20, the donor moves selected funds from an account to a financial instrument, for example, a MEC, designating an entity, for example, the NPO as the beneficiary of the MEC, at block 22. The funds from the death benefit are used, for example, to fund an endowment of the NPO. An agent of record, and/or a third party, is assigned for the MEC, at block 24, to whom communications on the MEC will be made to and from. The agent of record and/or the third party will monitor the status of the MEC, at block 26.
6. The agent of record continues to service policies for the donor owners, and the agent of record or third party provides a periodic report to the NPO detailing the total endowment goal, the number of policies and their death benefit in place to meet this goal, an actuarial determination as to when the NPO can reasonably expect to start tapping into death benefit proceeds, the financial impact the loss of certain key donors will have to the NPO, and the amount of the above mentioned death benefit in place that will replace lost key donor income.
7. The FNFP may become part of the planned giving section in the NPO's donor base brochure, as a choice for all potential donors. It also can be a footnote in financial statements, even though not an asset of the NPO, and can be a line item on the NPO's fund raising report to donors.
8. The FNFP information being reported will hopefully generate questions and other activity from the regular donor base on an ongoing basis.
9. If a donor decides to change the beneficiary to someone other then the NPO, the agent of record or third party will be notified by the insurance company by the company associated with the financial instrument, at block 28. If no, the process moves to block 30, where it temporarily ends for this particular donor. Otherwise, the NPO armed with the knowledge of the report will identify and approach other donors in its donor base to transfer more funds, and bring the death benefit back in line with projected endowment goals, returning the process to block 20. This reporting process may be the most important element of the FNFP: Giving the NPO the ability to track potential endowment funds earmarked for them, as well as the approximate time in which they may begin to be tapped.

While preferred embodiments have been disclosed, so as to enable one of skill in the art to practice the disclosed subject matter, the preceding description is intended to be exemplary only. It should not be used to limit the scope of the disclosed subject matter, which should be determined by reference to the following claims.

What is claimed is:

1. A method for a not-for-profit organization to monitor the projected amount and estimated date of receipt of an endowment bequest comprising:
a benefactor, through an associated agent, entering into a financial instrument bequeathing a set percentage of the instrument's proceeds to the not-for-profit organization;
a third party entering into a database the value of the financial instrument, the percentage of the bequest assigned to the not-for-profit and the age of the benefactor;
the third party calculating the value of the endowment gift based upon the current value of the financial instrument and the percentage bequeathed to the not-for-profit organization at the actuarially computed date of death of the benefactor;
the third party advising the not-for-profit organization on a regularly scheduled basis of the current value of the endowment gift and the projected date of receipt of the gift; and
the third party alerting the not-for-profit organization of a change in the status of the benefactor's financial instrument.

2. The method of claim 1, wherein the financial instrument is a modified endowment contract.

3. The method of claim 1, wherein the financial instrument is a life insurance policy.

4. The method of claim 1, wherein the financial instrument is an annuity.

5. The method of claim 1, wherein the financial instrument is an individual retirement account.

6. The method of claim 1, wherein the financial instrument is a transfer on death account.

7. The method of claim 1, wherein the associated agent is an insurance agent.

8. The method of claim 1, wherein the associated agent is a company associated with a financial instrument that may be obtained by a potential donor without assistance of a financial advisor.

9. The method of claim 1, wherein the step of entering into the financial instrument comprises the step of the benefactor authorizing the creation of the instrument by the associated agent and the transfer of a predetermined amount of funds from the benefactor to the financial instrument.

10. The method of claim 1, wherein the step of advising the not-for-profit organization on a regularly scheduled basis of the value of the endowment gift being bequeathed and the projected date of receipt of the gift comprises the step of making available to the not-for-profit organization a report detailing the estimated value of the bequest and the projected date of the receipt of the bequest.

11. The method of claim 1, wherein the step of the third party alerting the not-for-profit organization of a change in the status of the benefactor's financial instrument comprises the steps of the benefactor requesting the associated agent revise the financial instrument, the associated agent advising the third party of the revision to the financial instrument and the third party alerting the not-for-profit of the change to the financial instrument.

12. The method of claim 1, wherein the change in the status of the benefactor's financial instrument includes a reduction in the value of the financial instrument.

13. The method of claim 1, wherein the change in the status of the benefactor's financial instrument includes an increase in the value of the financial instrument.

14. The method of claim 1, wherein the change in the status of the benefactor's financial instrument includes a revocation of the financial instrument.

15. A system for a not-for-profit organization to monitor the magnitude of endowment bequests and the projected date of receipt of the endowment bequests, the system comprising: a benefactor desirous of bequeathing funds to a not-for-profit upon her demise; an associated agent to facilitate the benefactor entering into a financial instrument, wherein the associated agent obtains pertinent data from the benefactor and monitors the status of the financial instrument throughout the life of the benefactor, the proceeds of the financial instrument being transferred to the not-for-profit organization upon the death of the benefactor; a third party for receiving the pertinent data from the associated agent, wherein the third party enters the pertinent data into a computer database and calculates the current value of the financial instrument, and the actuarially projected date of demise of the benefactor and regularly advises the not-for-profit organization of the financial instrument's projected value upon demise and projected date of the receipt of the funds; the associated agent further advising the third party of any change in the status of the financial instrument by the benefactor.

16. The system of claim 15, wherein the financial instrument is a modified endowment contract.

17. The system of claim 15, wherein the financial instrument is a life insurance policy.

18. The system of claim 15, wherein the financial instrument is an annuity.

19. The system of claim 15, wherein the financial instrument is an individual retirement account.

20. The system of claim 15, wherein the associated agent is an insurance agent.

21 The system of claim 15, wherein the associated agent is a company associated with a financial instrument that may be obtained by a potential donor without assistance of a financial advisor.

22. The system of claim 15, wherein the pertinent data comprises the type of financial instrument, the current value of the financial instrument, the percentage of the total value of the financial instrument being bequeathed to the not-for-profit organization and the current age of the benefactor.

23. The system of claim 15, wherein the third party is an entity established to manage a database containing the pertinent data on each benefactor, receive data from at least one associated agent and report to at least one not-for-profit organization.

24. The system of claim 23, wherein the third party entity is a fee based entity that receives fees from the not-for-profit organization to provide the defined service.

25. The system of claims 15, wherein the changes in the status of the financial instrument by the benefactor includes a reduction in the value of the financial instrument.

26. The system of claims 15, wherein the changes in the status of the financial instrument by the benefactor includes an increase in the value of the financial instrument.

27. The system of claims 15, wherein the changes in the status of the financial instrument by the benefactor includes a revocation of the financial instrument.

28. A method for funding an organization to a predetermined amount at a predetermined time, including:
providing a plurality of donors, each with a financial instrument, each of the financial instruments including at least one not for profit organization as a designated beneficiary; and,
monitoring each instrument for beneficiary changes.

29. The method of claim 28, wherein the financial instrument is a modified endowment contract or other financial instrument.

30. The method of claim 28, additionally comprising:
providing at least one additional donor with a MEC, or other financial instrument with a beneficiary provision, to compensate for the loss of a portion of the predetermined amount at a predetermined time, if a beneficiary change to a MEC, or other financial instrument with a beneficiary provision, is detected.

31. The method of claim 28, additionally, changing the beneficiary of at least one MEC, other financial instrument with a beneficiary provision, of a subject from the plurality of subjects to a first organization, from a second organization, if a beneficiary change from the first organization is detected.
